(19) United States
(12) Patent Application Publication
(10) Pub. No.: US 2014/0015832 A1
(43) Pub. Date: Jan. 16, 2014

(54) System and method for implementation of three dimensional (3D) technologies

(71) Applicants: Dmitry Kozko, Aventura, FL (US); Ivan Onuchin, Hollywood, FL (US); Nikolay Shturkin, Yekaterinburg (RU)

(72) Inventors: Dmitry Kozko, Aventura, FL (US); Ivan Onuchin, Hollywood, FL (US); Nikolay Shturkin, Yekaterinburg (RU)

(21) Appl. No.: 13/373,196

(22) Filed: Nov. 8, 2011

Related U.S. Application Data
(60) Provisional application No. 61/575,503, filed on Aug. 22, 2011.

(51) Int. Cl. G06T 13/60

(52) U.S. Cl. CPC G06T 13/60
USPC 345/420

(57) ABSTRACT

A system and method of the present invention is a video reconstruction provided to reconstruct animated three dimensional scenes from number of videos received from cameras which observe the scene from different positions and different angles. Multiple video footages of objects are taken from different positions. Then the video footages are filtered to avoid noise (results of light reflection and shadows. The system then restores 3D model of the object and the texture of the object. The system also restores positions of dynamic cameras. Finally, the system maps texture to 3D model.

### RELATED APPLICATIONS

This is a non-provisional application that claims priority to a provisional application Ser. No. 61/575,503 filed on Aug. 22, 2011 and incorporated herewith by reference in its entirety.

### FIELD OF THE INVENTION

The present invention relates to a field of video processing and virtual image generation by video based reconstruction of events in three dimensions, and more particularly this present invention relates to a method and a system for generating a 3D reconstruction of a dynamically changing 3D scene.

### BACKGROUND OF THE INVENTION

In computer vision and computer graphics, 3D reconstruction is the process of capturing the shape and appearance of real objects. This process can be accomplished either by active or passive methods. Currently, 3D reconstruction process is used in various industries including entertainment industry, such as video games. Typically, games played in various public venues such as stadium, race tracks, and the like are watched by spectators from a seating area or a stadium luxury box. There is no way for the sports fan to interact with information about the game or with other similar sports fans. In recent years, many systems have been proposed to allow the 3D reconstruction of the scene. Typically, a person who tries to reconstruct animated 3D scene from several video footages will encounter following problems. One of these problems is failure to identify precise positions of cameras to get correct results. The error in several centimeters on in several degrees in camera direction or tilt may result to errors in several meters in the position of objects. Another problem is lack of time synchronization of cameras. Even if two or more cameras observes the same area, the difference in time may result to wrong object positioning when try to merge trajectories received from different cameras. For fast moving objects (such as racing cars, airplanes, or even running football player) the time difference in 1 second may result to positioning error in several meters.

It is important to stabilize image, because cameras always moving. Unless camera rigidly mounted in the concrete wall, it will always move. In real life it is usually hard to achieve strong fixation of cameras. Usually the higher camera is installed the better footage for 3D Video Reconstruction. When mounting cameras on the lighting piles, the wind may oscillate the pile and pile may go into resonance vibration. In this case footage from camera may move significantly, which may result in errors objects positions of tens meters order.

Another type of image correction required when camera is not fixed properly and it is slowly moving because of earth gravity force. In this case it is almost invisible change on the near frames, but if compare two images acquired with difference in 10 minutes, the change in objects position may result in errors of tens meters.

Alluding to the above, there is also a need to cleanup video footage. When video footage is done outside of the buildings in a natural lighting conditions, then video footage may be damaged by clouds, or some natural phenomena such as rain, snow, smog, etc. So the video footage should be cleaned up to remove the consequences of such natural phenomena.

There is a need to approximate objects' animation. Sometimes it is impossible to cover all area with good video footage. For example video cameras cannot be installed in certain parts of the race track for safety reasons. In this case either some area may not be covered with video footage, or video footage can be done from long distance, which results to low resolution images. Approximation based on the physical model of moving objects and scene should be used to restore animation.

It is important to restore high quality 3D models and textures for objects. Because 3D video reconstruction is heavily based on image processing, and comparison of existing video footage with virtual image of 3D objects, it is very important to have as much precise 3D models and detailed textures as possible as well as know other properties of objects' surface. It is good if all object models are known ahead of start calculation of position of objects. But in real life it is required to restore shape and textures of objects on the fly. For example even if we know that certain race has only Ferrari 458 cars. Every car has unique shape and images on the car body. The more precise 3D model of the car and texture the easier to recognize this car on video footage and the more precise result. There is also a need to suppress video noise. In real life there is a noise may be introduced in video footage. For example spots of specular lighting from the sun or artificial lighting may be presented on car bodies. Because in most cases it is very difficult to simulate complete environment, the virtual image will differ from one on the video footage. This may result to wrong object identification.

Finally, there is a need to restore animated 3D scene from video footage from moving cameras. Sometimes it is impossible to cover all area with good video footage from static cameras. In this case it make sense to install cameras on moving objects which will capture video of surrounding environment and then use this video to improve results captured from static video cameras.

The art is replete with various designs. For example, as published in the paper “A Video-Based 3D-Reconstruction of Soccer Games”, T. Bebie and H. Bieri, EUROGRAPHICS 2000, Vol. 19 (2000), No. 3, there is a description of a reconstruction system designed to generate animated, virtual 3D (three dimensional) views from two synchronous video sequences of part of a soccer game. In order to create a 3D reconstruction of a given scene, the following steps are executed: 1) Camera parameters of all frames of both sequences are computed (camera calibration). 2) The playground texture is extracted from the video sequences. 3) Trajectories of the ball and the players' heads are computed after manually specifying their image positions in a few key frames. 4) Player textures are extracted automatically from video. 5) The shapes of colliding or occluding players are separated automatically. 6) For visualization, player shapes are texture-mapped onto appropriately placed rectangles in virtual space. It is assumed that the cameras remain in the same position throughout the video sequence being processed.

Another prior art reference, namely European Patent No. 1 465 115 A2 describes the generation of a desired view from a selected viewpoint. Scene images are obtained from several cameras with different viewpoints. Selected objects are identified in at least one image, and an estimate of the position of the selected objects is determined. Given a desired viewpoint, positions of the selected objects in the resulting desired view are determined, and views of the selected objects are rendered using image date from the cameras.

In theory it is required to resolve mathematical problem to reconstruct object positions from several video footages, but in real life there are some challenges which should be overcome to get quality result. The overcoming these challenges require sophisticated and unique approaches which are described below in this patent. All these and other problems and their solutions will be described below in the patent.

Therefore, an opportunity exists for an improved system and method for 3D reconstruction of scenes that can be used in various industries, such as for example entertainment industry wherein the 3D scenes reconstructed from footage taken at the real time events will be of a good quality and suitable for enhancing the enjoyment of entertainment events performed in an area being monitored and filmed.

### SUMMARY OF THE INVENTION

A system and method of the present invention is used for a video reconstruction provided to reconstruct animated three dimensional scene from number of videos received from cameras which observe the scene from different positions and different angles. Multiple video footages of objects are taken from different positions. Then the video footages are filtered to avoid noise (results of light reflection and shadows). The system then restores 3D model of the object and the texture of the object. The system also restores positions of dynamic cameras. Finally, the system maps texture to 3D model and simulate visual effects.

An advantage of the present invention is to provide the improved system and method for 3D reconstruction adaptable to identify precise positions of cameras to get correct results to eliminate error in several centimeters on in several degrees.

Another advantage of the present invention is to provide the improved system and method for 3D reconstruction adaptable to synchronize cameras in time even if two or more cameras observes the same area, thereby eliminating the difference in time that may result to wrong object positioning when try to merge trajectories.

Still another advantage of the present invention is to provide the improved system and method for 3D reconstruction adaptable to approximate objects' animation.

Still another advantage of the present invention is to provide the improved system and method for 3D reconstruction adaptable to restore quality 3D models and textures for objects.

Still another advantage of the present invention is to provide the improved system and method for 3D reconstruction adaptable to suppress video noise and to simulate complete environment and eliminate difference between images from one on the video footage 3D reconstructed animation.

Still another advantage of the present invention is to provide improved system and method adaptable to restore animated 3D scene from video footage from moving cameras to cover all area with good video footage from static cameras.

Still another advantage of the present invention is to provide improved system and method for generation 3D visual effects, to simulate real-life phenomena such as fire, rain, dust, water etc. from the video footage.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a top view of initial stage of the present invention wherein a plurality of cameras are installed about the perimeter of a moving object such as, for example, a race car, in order to capture video footages to restore 3D object model and texture; Cameras are positioned in such ways to capture every point of moving object surface with at least two cameras.

FIG. 2 illustrates a schematic view of FIG. 1 taken from a side;

FIG. 3 illustrates another schematic view of FIG. 1 taken from a front;

FIG. 4 illustrates a schematic view of a race track with a plurality of vehicles moving along the race track and a plurality of cameras positioned around the race track; Cameras are installed in such a way to capture every point of racing track in good resolution with at least one camera.

FIG. 5 illustrates a schematic view of a field, such as, for example, a football field, with a plurality of cameras positioned around the field;

FIG. 6 illustrates a view from the camera installed on the track illustrating track borders and object moving vectors;

FIG. 7 illustrates a restored trajectory probability map shown in 3D;

FIG. 8 illustrates a diagram of 3D model and texture of an object; and

FIG. 9 illustrates a diagram of reconstruction of 3D scene.

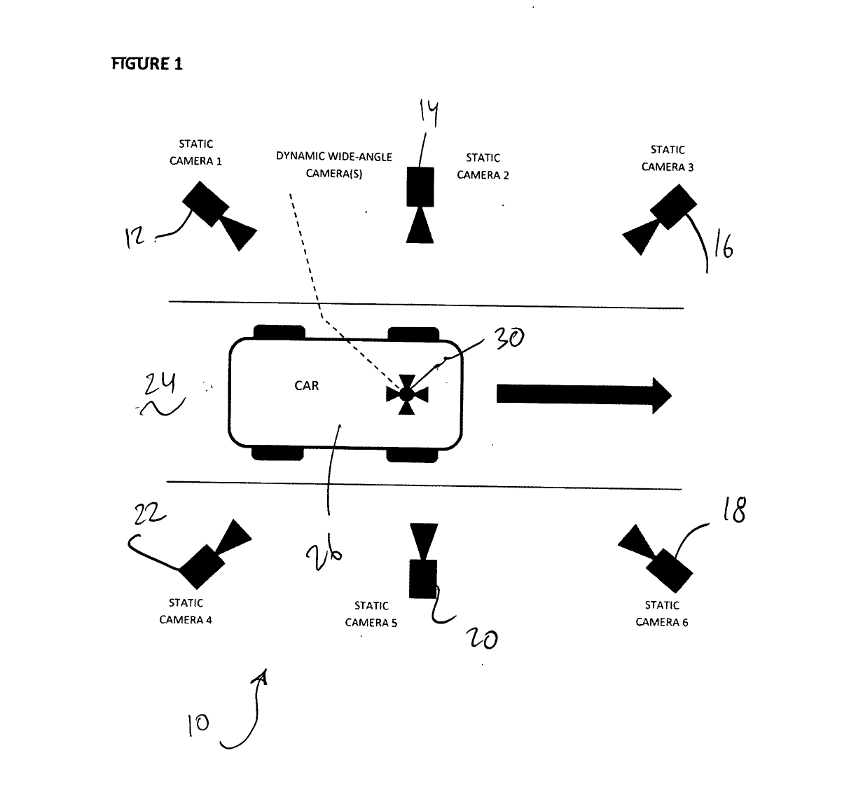

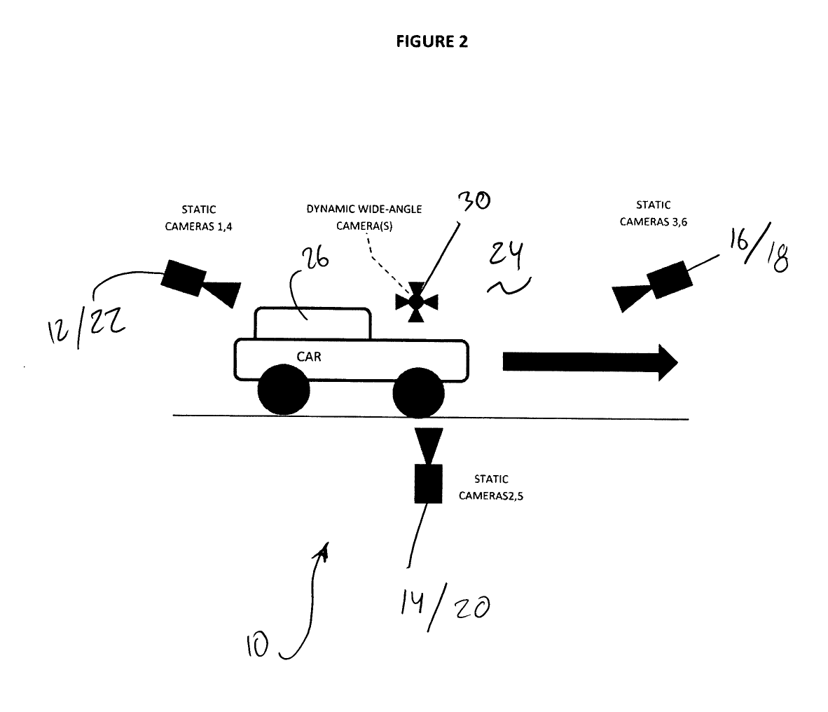

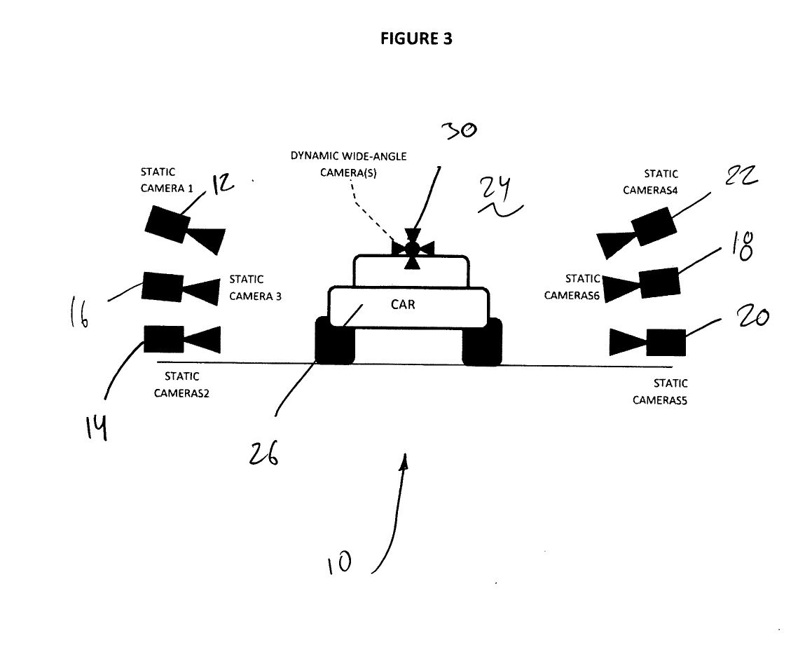

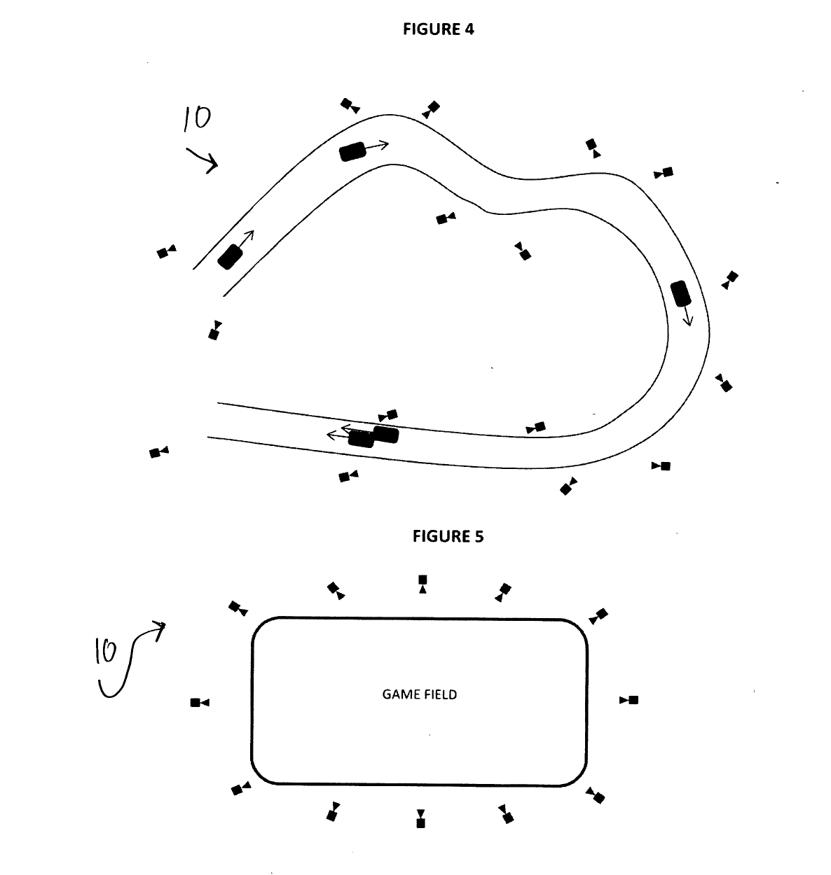

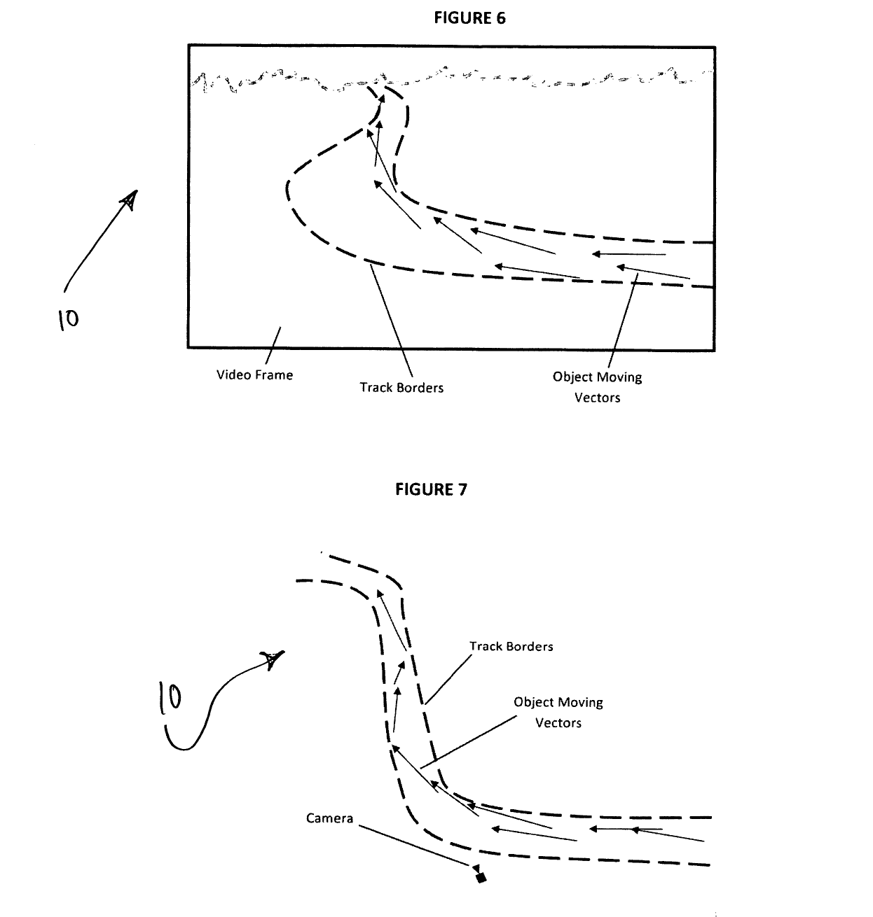

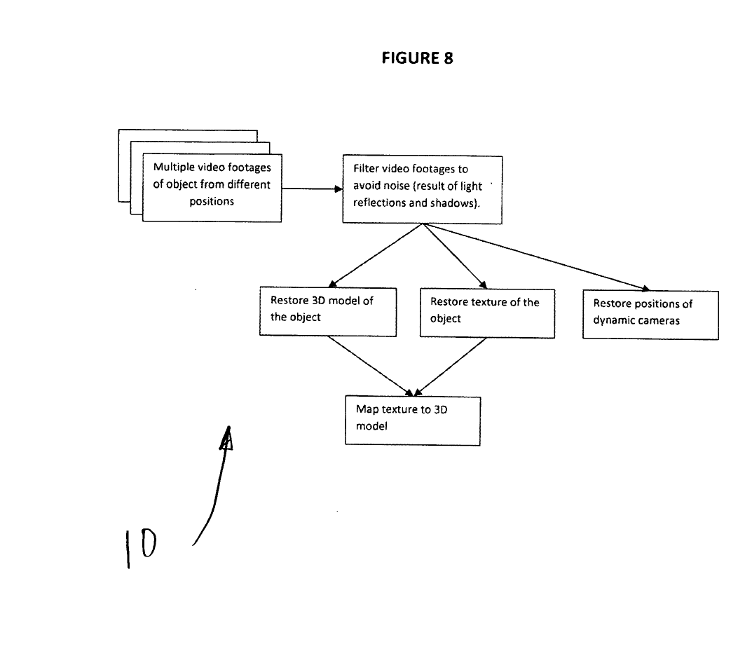

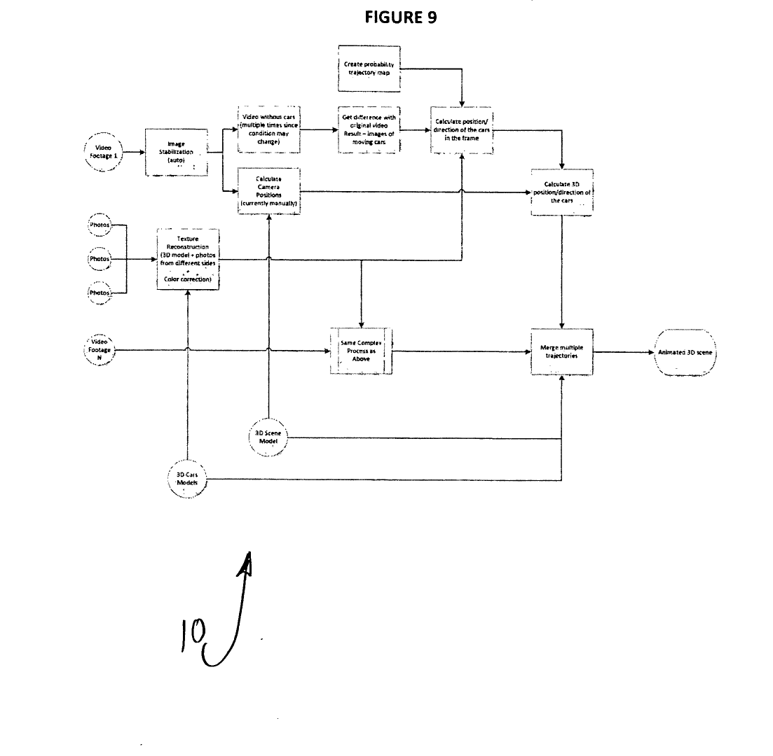

### DETAILED DESCRIPTION OF THE INVENTION

A system and method of the present invention is a video reconstruction provided to reconstruct animated three dimensional scenes from number of videos received from cameras which observe the scene from different positions and different angles. In general, multiple video footages of objects are taken from different positions. Then the video footages are filtered to avoid noise (results of light reflection and shadows. The system then restores 3D model of the object and the texture of the object. The system also restores positions of dynamic cameras at every moment of time relatively set of static cameras. Finally, the system maps texture to 3D model.

The system and method of the present invention includes multiple sub assemblies that allow reconstructing 3D product. One of these sub assemblies is a camera calibration that allows the system to determine actual camera positions. There are two types of calibration such as a video only calibration and a mixed photo-video calibration. In the video only calibration approach, the system locates so called “key points” in each view. These key points are then matched together. The system then determines optimal transformation from each view to another (use RANSAC or any other method) to get fundamental matrix. Finally, the system then calculates transformation from each view to global coordinate system (usually top-view).

Referring now to the mixed photo-video calibration, the system takes few photo shots from positions close to camera positions. The system then finds key-points in each photo, and each video-view. The system matches video view to near photo views and matches photo views between each other. The system then determines transformation between all views and global coordinate system. If one camera is visible in another camera, then it is possible to identify position of first camera with precision down to millimeters. For example, in case of race another camera may be installed on the car, and it may capture the positions of static cameras installed along the racing track. The key point in this example is that camera on the car may move as close as few meters to the static cameras, so static cameras will be well visible and their precise positioning becomes possible. To improve visibility of static cameras they may be marked with special patterns or flashing lights with certain flashing pattern. The system also includes a time synchronization sub assembly. The serious problem in 3D reconstruction applications is high-precision global time synchronization. All objects we have in scene are determined in 4 dimensions (x,y,z,t) plus (also time-dependent) transformation matrix (geometric basis). So, in case of wrong time synchronization serious coordinate precision loss is possible. This problem is especially important in the areas of space related to cross-section between adjacent cameras. For example, we track an object, and in some moment tracking should be switched to the next camera. How to determine current location, how to paste trajectories together? Obviously, in case of knowing exact global time all what we need to do is just to get positions, tracked on the both cameras in exactly the same moment of time and interpolate it. But when we don't know exact time we get space-time uncertainty, and need to solve more difficult system of equations to find the less noisy solution.

The system of the present invention includes a single global synchronization event (like massive light flash). The system then presents a set of globally synchronized clocks, to show it to each camera in the start and in the end of capturing, and then use number recognition module (or manual recognition) to extract exact time. It is important to analyze not only the numbers itself but also the moment of changes between numbers, to get more precise estimations. The system includes a image stabilization sub assembly. This assembly includes a controller and algorithm applied to each video stream.

This sub assembly detects key-points in the each frame of video and then choose one frame as reference. The system then match points in each frame to that reference and filters out points with significant motion on consecutive frames and points with low contrast. The system then computes transformation (using RANSAC or other similar method) between each frame and reference frame. The system then applies this transformation to each image to get stabilized video.

The system also includes a texture reconstruction sub assembly. Let's assume that we have approximate shape model of each object. Then, the system put some UV map onto its surface. The system then gets approximate initial position using some external method (like key-points detection and matching or specific methods like object recognition and localization, or using results of previous iterations)

The system then renders object for each view multiple times, by using slightly modified setup (position/rotation/scale/FOV parameters) in the neighboring with radius R using UV colorcoded map like texture. The system then projects each initial image (from each view) onto computed UV-map using incoming UV coordinates like positions in the destination image. For each view choose setup giving less distortion relatively to other images. Overall setup (the set of setups, one for each view) could be interpreted like output for the iteration, and computation process can be restarted using such setups as initial positions and using decreased R. On the final iterations shape model deformations could be applied to improve fitting.

As alternative scheme it is proposed to place several video cameras along the way of moving object. Then find similar features on the video footages and restore their 3D positions. This method will work in case if approximate shape of the object is not known. To improve object recognition the various methods of modeling surrounding environment from multiple video footages may be used. For example, while object is absent in the field of view of static cameras, they may capture surrounding environment (ground, sky, walls etc). Then if object with reflecting surfaces comes to the field of view, the modeling algorithm can eliminate such reflections and reduce amount of visual noise on the object.

The system also includes a background removal sub assembly. When we have pre-stabilized video we need to remove noisy static background to reduce computation complexity for next stages. For example, the system will get several (N) consecutive pre-stabilized video frames, then compute median color value for each pixel and put it into output image. When N is relatively large, this is the true diffuse background image. Then we subtract original image from this background, filter difference map, and compute envelopes. Pixels outside envelopes are treated like background. Inside—as possible objects.

The system also includes an object matching sub assembly. For each configuration of rigid object we create image cache, containing pre-rendered images, related to the object's view for each angle, scale, FOV by some small step. This images are pre-scaled to some fixed resolution. When we know object/background masks for each image, we try to fit this images into object masks. Especially, we try to find such setup (a combination of {angle, scale, FOV}) for each object to minimize perception error (e.g. squared pixel difference). Such setup is treated like hypothesis for object location. When we have a relatively big set of setup hypothesis, we detect the most plausible trajectory, which is most relevant to the predefined model of object movements (for example—for moving cars we ignore trajectories with jumpy turns on high speeds, etc.) Such filtering gives us some “trajectory bush” for each object which is still plausible and needs additional filtering. We may use fitting by longer sequence of consecutive frames or try to glue trajectories from different cameras to filter out not relevant paths.

The system also includes a 3D module. When we have a complete trajectory for each object we generate timeline. And we have a component able to react onto user input, and rewind whole objects configuration in the scene using determined trajectories like a function of position/rotation of time.

A result of 3D video reconstruction module is a trajectory—an ordered set of points with known coordinates and time. By this set of point it is necessary to build a smooth trajectory, by interpolating values of coordinates in known moments of time. It may be done by e.g. splines. Sometimes it is impossible to cover whole area by high quality video footage. For example, video-cameras can't be places on some segments of track because of safety reasons. In such cases segment of track will be not captured, or it may be shot from long distance, that leads to low resolution. Because of this it is necessary to approximate a motion of 3D models on such track segments, using only such rough information. And objects should move by the real physical laws. To reconstruct animation on such segments we use approximation, based on physical model of moving objects and scene. It is based on definition of such function to determine thrust, brakes and turning, which optimizes virtual object trajectory to the real one, extracted from the reconstruction module. And movement of such virtual object seems realistic, and error relatively to real trajectory is minimized.

There are two reconstruction modes: 3D broadcasting mode and game mode. The goal of 3D broadcasting mode is maximum realism and best reconstruction of real trajectories and object parameters. To reach this it is allowed to use improved models of physical characteristics of objects, to let them to return to trajectory after tracking loss, to speed-up and brake-down. Viewers interaction with scene in this mode is limited, but it is possible to view 3D broadcasting from any position at any angle; also to switch cameras displaying objects from external positions or even from inside of object.

Other is game-mode. It is dedicated for not only viewing reconstructed real event, but also to interact and participate in it, by controlling one of the objects. Player may use keyboard, mouse, sensor pad, touch screen or any other tracking technology or device available. The process of controlling is similar to usual simulators. Player may participate in crashes and affect movement of other players and virtualized objects. In case of trajectory loss virtual objects are trying to restore their actual position and synchronize it with the one received from reconstruction module. In game mode there is the way to find detours automatically. After collision of objects and inevitable de-synchronization with recorded positions, object may cross each other trajectory. In such cases objects should find the ways to avoid recurring collisions thru search of alternative trajectories. There is the way to generate a base of alternative trajectories, generated for exact track. Trajectories for exact segment may be taken from several laps or even from several events, including current event. In moment of trajectory switch object starts to reach its points. And time is being projected on the new trajectory using optimal normal vector connecting old and new trajectories.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system and method of the present invention presents a video reconstruction provided to reconstruct animated three dimensional scenes from number of videos received from cameras which observe the scene from different positions and different angles wherein said system and method further includes a plurality cameras taking video footages of objects are taken from different positions followed by filtering of said video footages to eliminate noise and restoring 3D model of said object and texture of said object followed by restoration of positions of dynamic cameras and mapping texture to a 3D model.

2. A system and method from the claim 1, which utilizes set of cameras positioned in such way to capture high quality 3D objects with textures and other surface properties.

3. A system and method from the claim 1 where dynamically located cameras are used to improve quality of resulting animated 3D scene, especially in locations where statically located cameras do not provide enough quality.

4. A system and method from claim 1 where physical model is used to simulate behavior of objects in real life.

5. A system and method from claim 1 where one or multiple event sources are used to synchronize multiple static and dynamic cameras.

6. A system and method from claims 1, which can restore 3D visual effects (such as fire, water, rain, dust etc), from one or multiple videos.

7. A system and method from claims 1, which can reconstruct animated scene with photo-realistic quality.

8. A system and method from claims 1, which can process information in real-time.

9. A system and method from claims 1 through 8 where all parts of the system either partially or fully autometed.
